(19) United States
(12) Patent Application Publication
(10) Pub. No.: US 2003/0080463 A1
(43) Pub. Date: May 1, 2003

(54) Process for ring-dyeing filaments

(75) Inventors: Jennifer Harris, So. Burlington, VT (US); Monroe Moore, So.Burlington, VT (US); Raymond G. Mainer, Hinesburg, VT (US); Mark Antell, Colchester, VT (US); Howard Fish, St. Albans, VT (US); Ronald Pratt, Winooski, VT (US)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(73) Assignee: SPECIALTY FILAMENTS, INC., Burlington, VT

(21) Appl. No.: 10/015,915

(22) Filed: Oct. 26, 2001

(51) Int. Cl. B29C 47/88

(52) U.S. Cl. 264/178 F; 264/210.8; 264/211.14; 425/68; 425/72.2

(57) ABSTRACT

An apparatus and a continuous process for manufacturing a ring-dyed polymeric filament. A filament, formed by melt extrusion is directly fed into a tank containing a dye solution for a predetermined period of time. The resulting ring-dyed filament includes an outer cross-sectional region colored with the dye and an inner cross-sectional region not colored with the dye. The outer cross-sectional region may be of uniform thickness over the length of the filament. A quenching step can be performed either before or during the ring-dyeing step.

### FIELD OF THE INVENTION

The invention relates generally to a continuous process for fabricating and ring-dyeing filaments such as those used in consumer and industrial products such as toothbrushes, hairbrushes, paint brushes, household brushes, janitorial and cosmetic brushes and vacuum cleaner brushes. Ring-dyeing refers to a process wherein a filament is fed into a tank containing a dye solution and held therein for a predetermined period of time to provide a ring-dyed filament having an outer cross-sectional region colored with the dye and an inner cross-sectional region not colored with the dye. Alternatively, the ring-dying processes of the present invention may be employed to provide a filament having multiple ring-dyed layers, each layer having a different color. For example, the filament could be dyed with a first, highly absorbable dye or pigment of a selected color, e.g., red, that penetrates the filament surface and extends across a substantial portion, but not the entire cross-section of the filament, and dyed with a second, less absorbable dye or pigment of a different selected color, e.g., blue, that penetrates the filament surface and extends across a less substantial portion of the filament cross-section. The resulting filament would include two ring-dyed layers, each having a different color, and an undyed central core. In this manner, during use, a first change in filament color indicates a first degree of filament wear, and a second change in filament color indicates a second, more severe degree of filament wear. Alternatively, rather than relying upon the varying rates at which dyes are absorbed in a filament to obtain varying degrees of dye penetration, the degree of dye penetration may be controlled by adjusting the period of time the filament is exposed to the dye solution bath or by adjusting the temperature of the dye solution bath. For example, it is known that when the temperature of a dye solution bath is increased, some pigments or dyes will exhibit a greater rate of penetration into a filament submersed in the bath.

Although the present invention illustrates filaments that are circular in cross-sectional shape, it should be understood that this invention is sufficiently broad in nature to contemplate filaments having different cross-sectional shapes, e.g., triangular, square, etc. Moreover, the process of the present invention may be employed on a filament having a uniform diameter or a non-uniform diameter, or taper, along its length such as is typical for paint brush filaments. Reference to monofilaments includes single layer and multiple layer filaments such as co-extruded filaments that, for example, include a core completely surrounded by one or more coverings or sheaths. Reference to monofilaments also includes multiple section filaments.

The resulting ring-dyed filament serves different purposes for different types of applications. For example, ring-dyed filaments are utilized in toothbrushes to provide the user with a visual indication of wear so the user can replace the worn toothbrush. As the toothbrush is used, the bristles change color in response to wear by abrasion from the teeth, other bristles, and toothpaste, and provides an indication of when the toothbrush should be replaced. Under prior art methods, filaments utilized in toothbrushes are ring-dyed utilizing a secondary batch process wherein groups of thousands of filaments, each about six (6) to fifteen (15) feet in length, are gathered into loosely formed long hanks, clamped and then hand-dipped into a hot dye solution.

Ring-dyed filaments are also utilized as paint brush bristles to provide a colored outer layer that is different in color than the core. Typically the outer layer of the paint brush bristle is ring-dyed a dark color while the core portion remains lighter in color or colorless. Often, the tips of paintbrush bristles are ground by mechanical abrasion to form a sharp tip which exposes the inner core that is lighter in color or colorless. Paintbrush bristle tips that have been ground leave fewer bristle lines during application of paint. Further, paint brush bristles are often split or frayed at their free ends into numerous segments to provide more flexibility and a softer appearance. The “soft tip” feature also helps the paint brush retain more paint which reduces the number of times it is necessary to redip the paint brush into a paint reservoir. Like the ground tip discussed above, the soft tip prevents bristle lines during paint application and assists in delivering paint smoothly and evenly while the remaining portion of the bristles retains a greater degree of stiffness. Alternatively, the free ends of paint brush bristles may be both ground and frayed.

The exposed bristle core, combined with the differently colored bristle outer surface provides an appearance at the bristle tips that is different from the remaining body of the bristles, which helps to distinguish the bristle tips from the remaining body. Since typically the outer surface of the bristle is dyed a relatively dark color and the core is lighter in color or colorless, the frayed or ground bristle tips appear lighter in color than the remaining body of the bristles. The differently colored bristle tips serve to distinguish paintbrushes having the soft tip feature from those not having this feature. The resulting two-color combination at the bristle tip provides a more natural look found in plants or animal hair which is considered desirable by consumers. Under prior art methods, short cut bundles of thousands of filaments about two (2) to about five (5) inches in length are ring-dyed in a secondary batch process by dipping them into a hot dye solution. Frayed or ground bristles are also provided in brooms to enable trapping and sweeping of small particles or for retaining cleaning media such as soap and water for washing. Therefore, the present invention could be employed on bristles utilized in these applications.

Hairbrush filaments or bristles also are ring-dyed to give the outer layer a different color than the filament core. At the free ends of the bristles, the two colors in each filament provide a natural and aesthetically desirable appearance. At their free ends, hairbrush bristles are rounded by mechanical abrasion, which removes sharp edges that might otherwise scratch the scalp. The mechanical abrasion process removes the outer dyed color of the bristle and reveals the color of the core. Like the frayed or ground free ends of the paintbrush bristles discussed above, the rounded ends of the hairbrush bristles differ in color from the remaining portion of the bristles to call attention to the rounded tip feature.

### BACKGROUND OF THE INVENTION

As briefly mentioned above, there are conventional processes described in the prior art for fabricating ring-dyed filaments that involve multiple steps. An exemplary conventional process may include a filament forming step wherein a molten polymeric composition is extruded through the aperture of a spinnerette or other type of die and cooled to form a filament. Following the forming step, one or more stretching steps may be performed which reduces the cross-sectional diameter of the filament and improves its physical properties. The filament may be subjected to heat during these stretching steps. Next, an annealing or heat setting step is performed, which also improves the physical properties of the filament. The filaments may also be crimped by passing them through gear-like rollers. The filament is passed over a roll that is coated with a lubricant in order to reduce its coefficient of friction. Finally, the finished undyed filaments are collected onto reels or spools. Under many conventional processes, the steps set forth above are conducted as part of a continuous in-line process.

Thereafter, a ring-dyeing step is conducted in a separate batch process wherein the filaments are unwound or cut from the reels or spools, gathered into loosely formed long hanks or short cut bundles (as mentioned previously), and contacted with a suitable dye solution for a time sufficient to at least color the surface and preferably to also penetrate into a portion of cross-sectional area to provide a degree of dye penetration. Thereafter, a batch finishing step is sometimes conducted wherein a lubricant is added to the outer surface of the dyed filament. The lubricant facilitates combing of the filaments, which often is necessary to align the filaments in parallel orientation. The lubricant also reduces the coefficient of friction of the filament surface to facilitate further processing of the filaments by high speed machines for assembly in toothbrushes, paintbrushes and other applications. This conventional multi-step process wherein toothbrush filaments are ring-dyed in loosely gathered long hanks and paint brush filaments are ring-dyed in short cut bundles has been and continues to be employed in the fabrication of filaments for toothbrushes as well as for paintbrushes, hairbrushes and other types of abrasive brushes.

For example, Breuer et al., U.S. Pat. No. 4,802,255, which is hereby incorporated by reference, describes a process for ring-dyeing brush filaments that before dyeing may be transparent, translucent or colored such as by dyes or pigments. The brush filaments have been formed prior to the ring-dyeing step utilizing any suitable process such as the continuous in-line process described previously wherein a moldable polymer is mixed and heated to form a flowable material which is then extruded to form an undyed filament which may then be taken through further forming steps to improve physical characteristics. Under the process of Breuer et al., small batches of the already formed filament are contacted with a dye for a time sufficient to at least color the surface and preferably to also penetrate into a portion of cross-sectional area to provide a degree of dye penetration. The resulting brush filaments include a colored region provided by a dye colorant. The colored region is adapted to provide a color intensity which can change in response to increased use of the filament to provide a signal indicative of filament wear. The specific dyeing procedures described by Breuer et al. are for laboratory samples and the filaments made in accordance with those procedures are included in the bristles of toothbrushes.

Likewise, Suhonen, U.S. Pat. No. 5,268,005, describes procedures for ring-dyeing large amounts of filaments, the filaments already having been formed by any suitable process, such as the continuous in-line process described previously. The resulting ring-dyed filaments are used in wearindicating toothbrushes that provide a consistent level of dye penetration.

There are several drawbacks to the multi-step processes described above. First, because the ring-dyeing step is conducted as a batch process that follows the forming steps rather than being integral with the forming steps, the overall process is less efficient, more costly, and more time consuming. Also, because the ring-dyeing is conducted in batches, additional handling is required for arranging the filaments into loose hanks prior to contact with the dye solution to ensure uniform flow around and penetration into the filaments. Also, where clamps are utilized for immersing the hanks into a dye solution, dye cannot be absorbed into the areas of the hanks that are contacted by the clamps during immersion. These areas must be cut out and discarded. Moreover, in the case of short cut bundles of thousands of paint brush filaments, the dye does not flow around all of the filaments sufficiently to produce a uniform filament color. Some filaments are darker or differently colored than others. The result is a large variation in filament color and a lack of desired uniformity and quality. Finally, desirable paint brushes are made from filaments that are straight. Filaments that are not straight are discarded. Under the prior art batch process, the hanks and short cut bundles are held loosely to allow the dye to wet and penetrate all surfaces of the filaments. Because the filaments are not held tightly in a straight position during dying they can curl during further processing and must be discarded.

Accordingly, it is a general object of this invention to provide processes that overcome the disadvantages of the prior art. The processes described and claimed in the present invention overcome these disadvantages by integrating the ring-dyeing step into the forming step, thus eliminating batch operations from the overall process. Also, by passing a filament through a tank filled with a dye solution immediately after the filament has been extruded, the amount of time required for penetration of the dye solution into the cross-sectional area of the filament is dramatically reduced while providing a uniform and consistent level of dye penetration over the length of the filament, which results in cost efficiencies. Moreover, the uniform and consistent level of dye penetration remains even after the filament is stretched to its final form. Further, under the present invention, because the ring-dyeing step is conducted in-line as part of the forming step rather than as a batch step following the forming step, less handling is required and less waste results. In addition, under the present invention, because the filaments are held tightly in a straight position during dying and further processing steps, more of the resulting filaments are straight which reduces waste.

The filaments resulting from the processes of the present invention possess an even and consistent level of dye penetration that compares favorably with the less efficient batch ring-dyeing process of the prior art. Short cut bundles of paint brush filaments fabricated and ring-dyed in accordance with the process of the present invention are highly uniform in color as compared with the batch ring-dying process of the prior art.

### SUMMARY OF THE INVENTION

The present invention relates to an apparatus and a continuous process for manufacturing a ring-dyed polymeric filament. A filament is formed from a continuously extruded polymer melt. The extruded filament is then directly fed into a tank containing a dye solution and is submerged within the tank for a predetermined period of time to provide a ring-dyed filament. The resulting ring-dyed filament includes an outer cross-sectional region colored with the dye and an inner cross-sectional region not colored with the dye.

Alternatively, the ring-dyeing processes of the present invention may also be employed to provide filaments having multiple ring-dyed layers, the layers being of different colors or uncolored.

The outer cross-sectional region of the filament may be of uniform thickness over its length, or, alternatively, the outer cross-sectional region may be of a non-uniform or tapered thickness, as is illustrated in FIG. 1B herein. Additionally, it is within the scope of this invention for the filament to include a hollow central axis, such as is illustrated for exemplary purposes in FIG. 1B.

A quenching step can be performed either before or during the ring-dyeing step. In an alternate embodiment, the step of quenching includes the step of utilizing positively driven feed rollers to direct the filament through a water bath.

In another alternate embodiment, the ring-dyeing step of the inventive process has a duration of between less than 1 and 30 seconds.

In another alternate embodiment, the filament is formed of a polyamide or a blend of a polyamide with another polymer.

In another alternative embodiment, the filament is formed of a polyester or a blend of a polyester with another polymer.

In another alternative embodiment, the filament is formed of multiple layers such as coextruded layers including a core formed of a suitable material, e.g., polyester, surrounded by one or more coverings or sheaths, wherein the outermost covering or sheath is formed of a polyamide or a blend of a polyamide with another polymer.

In another alternate embodiment, following the ring-dyeing step, the process comprises the further step of directing the filament into a first heated zone under a predetermined tension and stretching the filament to a predetermined cross-sectional dimension.

In another alternate embodiment, the stretching step comprises multiple stretching steps.

In another alternate embodiment, following said stretching step, the process comprises the further step of passing the filament through a second heated zone under a controlled degree of relaxation and annealing or heat setting the filament.

In another alternate embodiment, immediately following the annealing step, the process comprises the further step of coating the filament with a lubricant.

In another alternate embodiment, the coating step includes the step of contacting the filament with a lubricant applicator roll.

In another alternate embodiment, the filament is passed through a set of gear-like crimping rollers to impart a wave shape along the filament axis.

In another alternate embodiment, the filament is formed of a suitable polymeric composition.

In another alternate embodiment, the annealing step includes the sub-steps of directing the filament through and out of an annealing oven by positively driven feed rolls.

In another alternative embodiment, the dye solution is an acid dye solution.

In another alternative embodiment, the dye solution is a disperse dye solution.

In another alternate embodiment, the acid dye solution comprises between 0.01% and 0.5% weight to volume of a suitable dye and more typically between 0.1% and 0.4% weight to volume of a suitable dye.

In another alternate embodiment, the disperse dye solution comprises between 0.1% and 1.0% weight to volume of a suitable dye and more typically between 0.4% and 0.7% weight to volume of a suitable dye.

In another alternative embodiment, the suitable acid dye solution has a pH between 0 and 7, and preferably between 0 to 4.5. More typically, the acid dye solution has a pH of between 1 and 3.

In another alternative embodiment, the suitable disperse dye solution has a pH between 0 and 7, and preferably between 4 to 6. More typically, the disperse dye solution has a pH of between 5 and 5.5.

In another alternative embodiment, the suitable acid dye solution is maintained at a temperature between 0 and 100 degrees C. and preferably between 20 and 100 degrees C. Under certain conditions, maintaining a suitable acid dye solution between 70 and 95 degrees C. will speed reaction time between the dye solution and the filament surface.

In another alternative embodiment, the suitable disperse dye solution is maintained at a temperature between 0 and 100 degrees C. and preferably between 40 and 60 degrees C.

In another alternate embodiment, immediately following the ring-dyeing step, the process comprises the further step of rinsing the ring-dyed filament.

In another alternate embodiment, the step of rinsing includes the step of utilizing positively driven feed rollers to direct the filament through a water bath to remove excess dye.

In another alternate embodiment, following the ring-dyeing step, the process comprises the further step of collecting the filament on a reel or spool.

In another alternate embodiment, following the ring-dyeing step, the process comprises the further step of cutting the filament to predetermined lengths then collecting the cut lengths and gathering them into bundles of cut filaments.

### BRIEF DESCRIPTION OF THE DRAWINGS

Other objects and many of the attendant advantages of this invention will readily be appreciated as the same becomes better understood by reference to the following detailed description when considered in connection with the accompanying drawings wherein:

FIG. 1 is an isometric view of a representative toothbrush including ring-dyed filaments made in accordance with the process of the present invention;

FIG. 1A is an elevational view of a representative paintbrush including ring-dyed filaments made in accordance with the process of the present invention;

FIG. 1B is an enlarged isometric view illustrating a tapered portion of a filament that may be utilized in a paintbrush or other type of brush that may be ring-dyed in accordance with the process of the present invention.

FIG. 2 is an enlarged isometric view, partially in section, illustrating a portion of a filament formed and ring-dyed in accordance with the process of the present invention;

FIG. 3 is an enlarged isometric view, partially in section, illustrating a portion of an alternative filament formed and ring-dyed in accordance with the process of the present invention;

FIG. 4 is a sectional view taken along line 4-4 of FIG. 2;

FIG. 5 is a sectional view taken along line 5-5 of FIG. 3;

FIG. 6 is a schematic side elevational view of an exemplary processing line for forming and ring-dyeing filaments in accordance with this invention;

FIG. 7 is a schematic side elevational view of a portion of an alternate embodiment of a processing line for forming and ring-dyeing filaments in accordance with an alternative embodiment of this invention; and,

FIG. 8 is a schematic side elevational view of a portion of a most preferred embodiment of a processing line for forming and ring-dyeing filaments in accordance with this invention.

### DETAILED DESCRIPTION OF THE PREFERRED EMBODIMENT

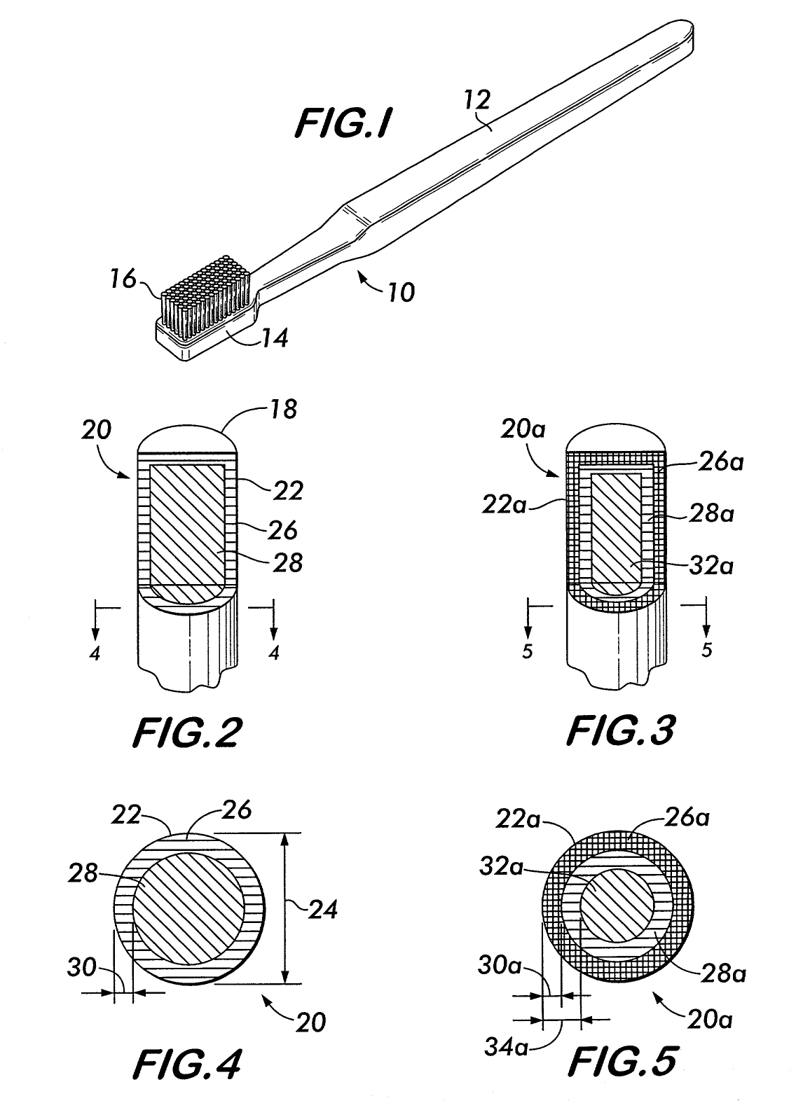

Referring now to the drawings where like reference numerals refer to like parts there is shown at 10 in FIG. 1 a toothbrush that includes a handle 12 and a head 14 having a plurality of tufts 16. The configuration, shape and size of handle 12 or tufts 16 can vary and the axes of handle 12 and head 14 may be on the same or different plane. The tufts 16 comprise a plurality of individual filaments 20 (FIG. 2) that have been formed and ring-dyed in accordance with the process of the present invention. The tufts 16 are securely affixed in or attached to the head 14 in manners known to the art. Although in FIG. 1, the filaments 20 are being utilized in tufts attached to the head 14 of a toothbrush 10, it should be understood that the present invention is not limited to forming filaments for use as toothbrush bristles and it is contemplated that the present invention can be employed for fabricating ring-dyed filaments utilized in other applications, such as those discussed above, e.g., hairbrush bristles, paintbrush bristles, broom bristles, household brush bristles, janitorial and cosmetic brush bristles, vacuum cleaner brush bristles, and other applications. Referring now to FIG. 1A, there is shown at 11 a paintbrush including a handle 13 at one end and a plurality of filaments 20 at the other end. The filaments 20 may be of uniform diameter. Alternatively, as shown in FIG. 1B, the filaments formed and ring-dyed in accordance with the process of the present invention and utilized in the paintbrush 11 may be tapered as indicated at 21 and/or may include a hollow central axis as indicated at 23.

In accordance with the broadest aspect of this invention, the filaments 20 formed and ringdyed in accordance with the process of the present invention may be formed of any polymer that is capable of being ring-dyed in accordance with this invention, e.g., polyolefin, polyamide, polyester, polystyrene, polystyrene copolymers, polyvinylchloride, polyvinylidenechloride, polyurethane, and fluoropolymers. The preferred materials for forming the ring-dyed filaments of the present invention are polyamides, blends of one or more polyamides with another polymer, polyesters, and blends of one or more polyesters with another polymer. Typical polyamides that may be employed in accordance with the process of the present invention include polyamide 6-12, polyamide 10-10, polyamide 6-10, polyamide 6-6 and polyamide 6 although other polyamides could be employed without departing from the scope of this invention. Typical polyesters that may be employed in accordance with the process of the present invention include polyethylene terephthalate (PET), polybutylene terephthalate (PBT), and polytrimethylene terephthalate (PTT), although other polyesters could be employed without departing from the scope of this invention.

The longitudinal and cross-sectional dimensions of the filaments 20 and the profile of the filaments 20 can vary. The stiffness, resiliency and shape of the filament also can vary. Preferred filaments utilized for toothbrush bristles have substantially uniform longitudinal lengths between about 3 to about 6 cm., substantially uniform cross-sectional dimensions between about 0.004 inches to about 0.014 inches and have smooth or rounded tips or ends. Filaments utilized for paint brush bristles may be of substantially uniform diameter along their lengths or may be tapered along their lengths and may include a hollow central axis. Typically, filaments utilized for paintbrushes are substantially longer and substantially thicker than toothbrush filaments.

FIGS. 2 and 4 diagrammatically represent a filament 20 formed and ring-dyed in accordance with the process of the present invention. As shown in FIGS. 2 and 4, a filament 20 includes longitudinal surface 22 which terminates at a tip or end 18 and defines the boundary of the cross-sectional area 24 of the filament 20. Cross-sectional area 24 includes two colored regions 26 and 28 which have different colors or different color intensities. Colored region 26 extends at least about the periphery of surface 22 or preferably extends from surface 22 inwardly into a portion of cross-sectional area 24 to provide a distance or degree of dye penetration 30 as best shown in FIG. 4. Preferably, colored region 26 provides an annular ring having a substantially uniform degree of penetration. In either event, region 28 which may be colored by pigmentation prior to ring-dying occupies the remaining portion of cross-sectional area 24. Alternatively, it is not required that region 28 be colored; region 28 may be clear or colorless in appearance. Accordingly, colored region 26 provides an initial color intensity or color which is predominant and more conspicuous to the user than the color intensity of region 28. However, in response to wear produced by progressive use, e.g., brushing, the initial color intensity resulting from the “wearing” of region 26 changes and after sufficient wear, the change in color intensity of region 26 signals the user that the filament 20 is no longer effective, and that the brush should be replaced.

Colored region 26 is provided by a ring-dyeing process. In ring-dyeing processes, the filament is contacted with a suitable dye, e.g., an acid dye or a disperse dye, for a time sufficient to at least color surface 22 and preferably to also penetrate into a portion of the cross-sectional area to provide a degree of dye penetration 30. Before ring-dyeing, the filaments 20 may be transparent, translucent or colored such as by dyes or pigments. In ring-dyeing polyamide brush filaments, acid dyes or colorants are preferably used in amounts ranging between 0.01% and 0.5% weight to volume of a suitable acid dye and more typically between 0.1% and 0.4% weight to volume of a suitable acid dye. Depending upon the amount of buffer, if any, the pH of such aqueous acid dye solutions can range from about 0 to about 7, and more typically is between 1 and 3. Suitable buffers include potassium phosphate, sodium hydroxide, potassium carbonate, potassium borate and potassium hydroxide. Representative suitable concentrations of buffers are between about 0.025 to about 0.2 moles per liter of the aqueous dye solutions. In ring-dying polyester brush filaments, disperse dyes or colorants are preferably used in amounts ranging between 0.1% and 1.0% weight to volume of a suitable disperse dye and more typically between 0.4% and 0.7% weight to volume of a suitable disperse dye. Depending upon the amount of buffer, if any, the pH of such aqueous dye solutions can range from about 0 to about 7, and preferably ranges between 4 to 6. More typically, the disperse dye solution has a pH of about 5 or 5.5.

The degree of dye penetration into and the degree of dye fastness to a selected filament is coordinated with the wear characteristics of the filament so that the change in color intensity provides a reliable indication of filament deterioration due to wear in toothbrushes. The degree of dye penetration and dye fastness both increase with increased dye solution temperature and with increased immersion time. For polyamide brush filaments, representative preferred acid dye solution temperatures are between 0 and 100 degrees C. and preferably between 20 and 100 degrees C. Under certain conditions, maintaining a suitable acid dye solution between 70 and 95 degrees C. will speed reaction time between the dye solution and the filament surface. For polyester brush filaments, representative preferred disperse dye solution temperatures are between 40 and 100 degrees C., with 95 degrees C. being preferred. The steps for forming both polyamide and polyester brush filaments of the present invention are carried out at or near atmospheric pressure. Representative preferred immersion times are between less than 1 second and 30 seconds. Dye rate enhancing solvents and/or surfactants may also be used to control the degree of dye penetration and dye fastness. At this juncture, it is important to mention that although it is preferred to use an acid dye for ring-dyeing polyamide brush filaments, a disperse dye may be substituted. The concentration, pH, temperature range and immersion time set forth above for disperse dying polyester filaments can be utilized for disperse dying polyamide filaments.

As mentioned, the filament of FIGS. 2 and 4 can be transparent or translucent or colored by pigments or dyes prior to being ring-dyed to provide region 26. Accordingly, after ring-dyeing and after being subjected to sufficient wear and use, the filament will present a substantially uniform color intensity which will at least approximate the initial color intensity of the pre-dyed filament. Additionally region 26 may or may not extend along the entire length of longitudinal surface 22. For example, region 26 can extend along only a portion of the length of surface 22 such as a portion including the filament tip, which is normally subjected to more intense conditions of wear than other portions of the filament 20. In this case, the color intensity of the portion of the length of surface 22 including region 26 will change in response to wear and use. After sufficient wear and use, the color intensity along the entire length of surface 22 will be substantially uniform.

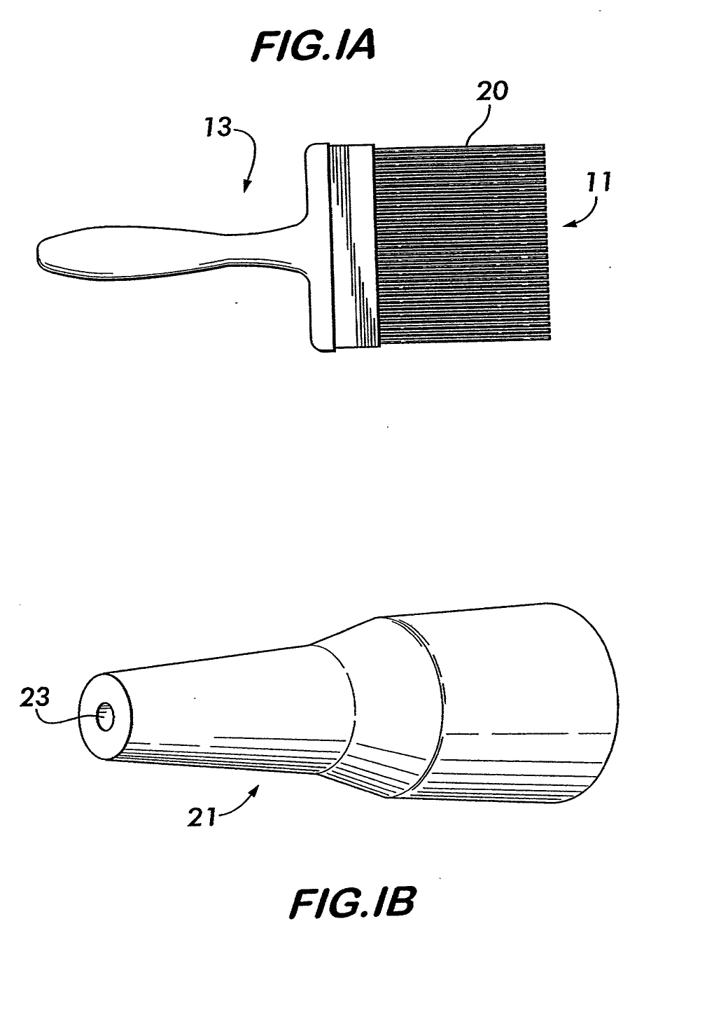

Ring dyeing processes may also be employed to provide filaments of the type shown in FIGS. 3 and 5 in which filament 20a has three regions 26a, 28a and 32a with each region having a different color. Referring now to FIG. 5, filament 20a may be prepared by ring-dyeing the filament with a dye of a selected color under conditions to provide a degree of dye penetration 34a. Simultaneously or following the application of the first dye, the filament is ring-dyed with a second dye of another selected color that is less preferentially absorbed than the first dye to provide a lower degree of dye penetration 30a. The degrees of dye penetration 30a and 34a can be adjusted. For example, the filament may be prepared so that the degree of dye penetration 34a of the first dye extends across only a portion of the cross-section of the filament resulting in two ring-dyed regions 26a and 28a and an uncolored central core 32a.

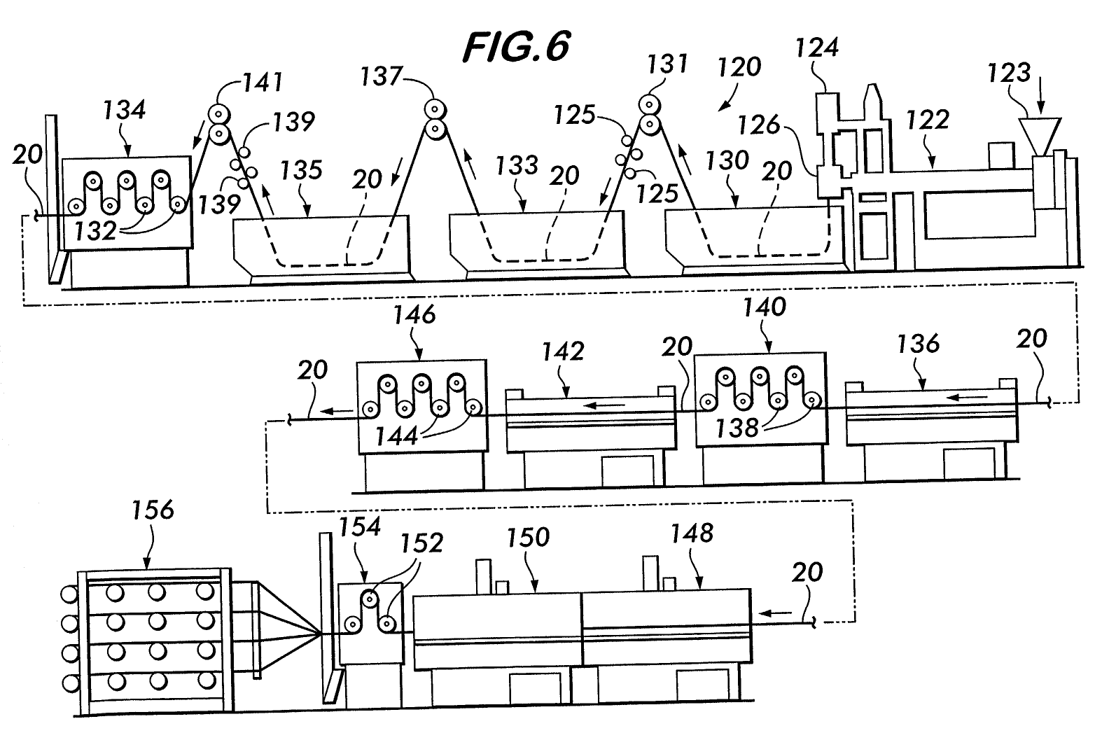

Referring now to FIG. 6, a schematic representation of a first exemplary process line usable to form filaments 20 in accordance with this invention is shown at 120. The upstream extruder 122 includes three separate funnel-shaped hoppers, only one being illustrated at 123. The funnel shaped hoppers 123 are arranged for feeding by gravity a raw polymer in the form of pellets to the extruder 122. Typically, polyamides that could be employed in accordance with the process of the present invention include polyamide 6-12, polyamide 10-10, polyamide 6-10, polyamide 6-6 and polyamide 6 although other polyamides could be employed without departing from the scope of this invention. Moreover, the inventive process contemplates the use of a mixture of one or more polyamides with other polymers. Typical polyesters that could be employed in accordance with the process of the present invention include polyethylene terephthalate (PET), polybutylene terephthalate (PBT), and polytrimethylene terephthalate (PTT), although other polyesters could be employed without departing from the scope of this invention.

The pellets may be blended off-line with pigments, other polymers and other additives and fed into one of the hoppers. Alternatively, the additives can be incorporated by the use of the multiple hoppers 123 each delivering a different material to a separate feed screw associated with that hopper that meters the material to a common throat below all of the hoppers 123 at the inlet end of the extruder. A desired color concentrate may be introduced into one of the hoppers. It should be understood that the coloring of the filaments 20 is optional and this step can be eliminated when the filaments to be formed are not intended, or required, to be colored. The three hoppers 123 are disposed circumferentially about the throat of the extruder 122 at the upstream end thereof, and each hopper empties into its own underlying feed screw (not shown). These feed screws (not shown) direct the materials from the overlying hoppers 123 into a common, upstream throat of a barrel of the extruder 122 for blending, melting and feeding in a downstream direction through several temperature controlled zones to a melt pump 124. The melt pump 124, contained in the head of the extruder 122, evens out the internal pressure and then directs the polymer melt through a spinnerette 126 at the downstream end of the extruder 122 to extrude the polymer melt to form continuous filaments 20 of a controlled cross-sectional size.

At this juncture it is important to mention that the filament 20 of the present invention is formed as the result of a melt extrusion process wherein a polymer, e.g., a polyamide or a polyester, is melted and then directed through the spinnerette 126 to form the filament 20. This melt extrusion process is in contrast to other filament forming techniques such as wet spinning or solution spinning wherein one or more solvents are added to a polymer, e.g., an acrylic, the resulting solution then being extruded through a die. Wet spinning and solution spinning techniques for forming filaments are determined to be outside the scope of the present invention. Also, it is important to mention that the present invention is directed to processes for ring-dying polymer filaments for use in applications such as toothbrushes and paint brushes and is not directed to processes for obtaining through-dyed fibers wherein the dye extends across the entire cross-section of the fiber, such as are employed in dying textiles or woven fabrics. Also, it is important to mention that fibers employed in dyed textiles or woven fabrics often have a substantially smaller cross-sectional dimensions than do filaments utilized in applications contemplated under the present invention.

Next, the continuous filaments 20 enter the atmosphere as a polymer melt and are immediately directed into a quench tank 130 containing a suitable quench medium, e.g., water, that is lower in temperature relative to the temperature of the polymer melt. The quench tank 130 cools and solidifies the polymer melt into its filament shape. The relatively cold temperature of the quench tank 130 helps to freeze the filaments 20 quickly to prevent large crystalline areas from developing within the typically semi-crystalline polymeric filament 20. Such unwanted crystallinity serves to increase chemical resistance in addition to making the filament cloudy and more opaque in appearance. A clear filament is also more aesthetically desirable. Amorphous or non-crystalline areas of the filament are considered more suitable for dye penetration than crystalline portions. A lubricant may be added to the water in the quench tank 130 to aid in preventing the hot filaments 20 from sticking to each other during quenching.

After the filaments 20 are pulled through the quench tank 130 by a set of nip or feed rolls 131, the filaments are contacted with a plurality of vacuum stripper tubes 125 that remove excess quench water from the filaments 20. Thereafter, the filaments 20 are pulled by a set of nip or feed rollers 137 through a dye tank 133. Where the filaments 20 are formed of polyamide, the dye tank contains between 0.01% and 0.5% weight to volume of a suitable acid dye and more typically between 0.1% and 0.4% weight to volume of a suitable acid dye. The suitable acid dye solution should have a pH between 0 and 7 and more typically between 1 and 3. The acid dye solution should be maintained at a temperature between 0 and 100 degrees C. and preferably between 20 and 100 degrees C. Under certain conditions, maintaining a suitable acid dye solution between 70 and 95 degrees C. will speed reaction time between the dye solution and the filament surface.

In the case where the filament 20 is formed of a polyester fiber, the dye tank contains between 0.1% and 1.0% weight to volume of a suitable disperse dye and more typically between 0.4% and 0.7% weight to volume of the suitable disperse dye. The suitable disperse dye solution should have a pH between 0 to about 7, and preferably ranges between 4 to 6. More typically, the disperse dye solution has a pH of about 5 or 5.5. The disperse dye solution should be maintained at a temperature between 0 and 100 degrees C. and preferably between 40 and 100 degrees C. with 95 degrees C. being most preferred.

The filaments 20 are moved at a speed to keep them immersed in the dye tank 133 for between less than 1 and 30 seconds. To achieve this period of immersion, the extruder speed, dimensions of the quench tank and path oftravel of the filaments 20 must all be carefully controlled. Under this embodiment separate tanks are provided for quenching and dying, i.e., the quench tank 130 and the dye tank 133. Such an arrangement may be necessary where it is necessary to quench at very low temperatures and dye at very high temperatures to obtain especially clear fibers. However, where clarity of the fiber is not of great importance, it may be possible to integrate the quenching and dying steps into a single step and perform both steps simultaneously in a single tank as is done in the second and most preferred embodiments discussed below. While the filament 20 is immersed, the dye penetrates into the outer cross-sectional region but not an inner cross-sectional region to form a ring dye. By conducting the dying step soon following the extrusion step rather at some point later in the process, e.g., following multiple stretching steps, any heat retained in the filament following the extrusion step may be utilized in the dying step for increasing the rate of penetration of the dye into the filament.

The filaments 20 for use on toothbrushes typically have a diameter of between 0.004 inches and 0.014 inches. Where utilized on paintbrushes, the filaments 20 are substantially thicker and may taper as illustrated in FIG. 1B. Typically, tapered filaments utilized on smaller paintbrushes may be approximately 0.007 inches at the thicker end and tapering to approximately 0.004 inches at the thinner end over a length of between 2.0 to 3.0 inches. Alternatively, for paintbrushes, the filaments may be approximately 0.009 inches at the thicker end and tapering to approximately 0.005 inches at the thinner end over a length of between 2.0 and 3.5 inches. Under yet another alternative embodiment, the tapered paintbrush filaments utilized on smaller paintbrushes may be approximately 0.012 inches at the thicker end and tapering to approximately 0.008 inches at the thinner end over a length of between 2.5 to 4.5 inches. Typically, on larger paintbrushes, the tapered filaments are approximately 0.015 inches at the thicker end and tapering to approximately 0.010 inches at the thinner end over a length of between 2.5 and 5.0 inches, however, thicker filaments may be utilized. Typically, paintbrush filaments of uniform thickness are approximately 0.008, 0.010 or approximately 0.012 inches in thickness. The dye tank 133 is heated by submerged heaters (not shown) to facilitate the reaction between the filaments 20 and the dye solution. Under the process of the present invention, a desired level of dye penetration can be achieved in a considerably shorter period oftime than under the batch processes of the prior art. For example, because the dye tank 133 is heated and because the filament continues to retain heat from the previous extrusion step, more rapid uptake of the dye by the filament surface results. Thus, the amount of time required to obtain a desired level of dye penetration into the filament 20 is greatly reduced. As previously stated, under the prior art processes where loosely formed hanks of filaments are contacted with a dye solution in a secondary batch step following the forming step, that ring-dyeing step takes between 30 and 60 minutes to obtain the desired level of dye penetration and absorption.

The filaments 20 are then pulled through a rinse tank 135 by a set of nip or feed rolls 141. The rinse tank 135 is filled with any suitable rinsing medium, e.g., cold water, to rinse any residual dye remaining on the filaments 20 as they exit the dye tank 133. It should be understood that the rinse tank 135 is necessary only when it is desired to rinse from the filament 20 excess dye remaining on the filament 20 following the dying step. If it is not necessary or required to rinse this excess dye prior to further processing steps, then the rinse tank 135 may be eliminated from the process line as shown and described in the most preferred embodiment of FIG. 8. The filaments 20 then are contacted with a second plurality of vacuum stripper tubes 139 that remove excess dye from the filaments 20.

The filaments 20 are then directed through a first oven 136 in which the filaments are stretched, or oriented by the pulling action that is imposed upon the filaments by the positively driven feed rolls 138 of a second roll stand 140 and the positively driven feed rolls 132 of a first roll stand 134, with all of the rolls 138 being driven at the same speed but faster than the rolls 132. Stretching is conducted for the purpose of axially orienting the long polymer molecules to improve the filament physical properties such as stiffness modulus.

The filaments 20 are then directed from the second roll stand 140 through a second oven 142 in which the filaments are further stretched, or oriented. This stretching or orienting operation is achieved by the pulling action that is imposed upon the filaments by the positively driven feed rolls 144 of a third roll stand 146 and the positively driven feed rolls 138 of the second roll stand 140, with all of the rolls 144 being driven at the same speed but faster than the rolls 138. Each filament 20 is typically stretched to about four times its original length, which results in a reduction of the diameter to approximately one-half its original diameter prior to stretching. The dying step is best conducted prior to the stretching step due to an increase in filament crystallinity and molecular orientation that occurs during stretching.

The number of stretching or orienting stages can be varied; however, one or two such stages are commonly employed when fabricating filaments. The filaments 20, after the final orientation step, are then directed through a pair of heat-setting ovens 148 and 150 in which the filaments 20 are relaxed by annealing (i.e., more crystallization). The filaments 20 are directed through and out of the ovens 148 and 150 by positively driven feed rolls 152 of a fourth roll stand 154. However, the rolls 152 of the fourth roll stand 154 are driven at substantially the same, or lower, speed as the rolls 144 of the third roll stand 146 to avoid stretching the filaments after they have been annealed.

After passing through annealing ovens 148 and 150, the filaments 20 are pulled by the rolls 152 of the last roll stand 154 and contacted with the top of a turning “finish” lubricant applicator roll 160, the bottom of which is turning in a dilute solution of an anti-static agent or a lubricant (not shown). The lubricant concentration and applicator roll 160 speed are carefully controlled to provide a consistent amount of lubricant on the filament surface. A controlled amount of lubricant on the surface of the filament is important as it facilitates the combing of the filaments that is often necessary to align the filaments in parallel orientation. The amount of lubricant added is important to obtain filaments 20 having a low coefficient of friction and predictable surface friction properties. Most importantly, use of a lubricant reduces the coefficient of friction of the filament surface to facilitate processing of the filament by high speed machines during assembly of the filaments into toothbrushes, paint brushes and other applications. Lubrication reduces static electricity on the filaments to facilitate controlled high speed processing and reduces the build-up of excessive heat. After contact with the “finish” lubricant applicator roll 160, the filaments 20 are directed onto a conventional collection reel 156. Although FIG. 6 illustrates a single filament being collected on the reel 156, it should be understood that in accordance with the present invention the reel is arranged for simultaneous collection any number of filaments from one to hundreds. Alternatively, the annealed filaments 20 may be cut to predetermined lengths and collected in a series of small bins. Such filaments cut to predetermined lengths may possess a non-uniform diameter or taper along its length such as is typical for paintbrush filaments.

Under the present invention, because the filaments 20 are ring-dyed in-line as a part of the continuous forming process, subsequent collection of the filaments 20 on collection reel 156 can be integrated and made a part of the continuous process. This offers a substantial efficiency over the prior art process where final collection was performed off-line following ring-dyeing which also was conducted off-line. Likewise, the finishing step is integrated and made a part of the continuous process of the present invention rather than being conducted as a secondary batch operation following the ring-dyeing step. In this manner, the filaments 20 can be collected on the collection reel 156 as completed ring-dyed and finished filaments 20 ready for other secondary processing or final packaging. Moreover, by integrating the finishing or lubrication step into the continuous in-line process, the lubricant is added to the filament 20 with a greater degree of control as compared with finishing conventionally batch ring-dyed filaments. This provides a significant benefit in achieving a consistent finish or lubrication to facilitate high speed automatic assembly of the filaments into brush handles with minimal static electricity and frictional heating.

The specific processing parameters, i.e., temperatures of the extrusion zones of the extruder, temperature of the quench tank, speeds of the rolls of the various roll stands, temperatures of the various ovens employed in the various stretching, orientation and annealing stages, etc., will depend upon a number of factors, including, but not limited to, the specific polymer composition being employed, the desired clarity/opacity of the filament, the desired residual lubricant remaining on the filament, the bristle stiffness, recovery-from-bending and other physical properties desired.

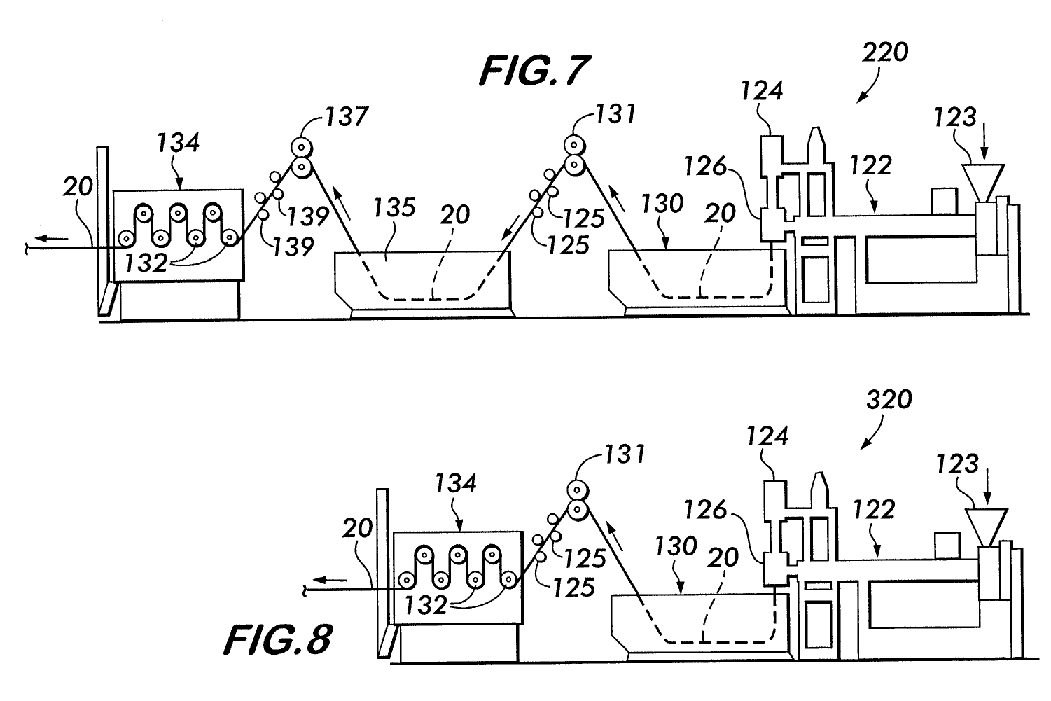

Referring now to FIG. 7, a schematic representation of a second exemplary process line usable to form filaments 20 in accordance with this invention is shown at 220. Under this embodiment, the dye tank 133, situated between the quench tank 130 and the rinse tank 135 has been eliminated. Rather, under this embodiment, the dye solution is added to the water in the quench tank 130. This embodiment may be utilized where it is not necessary to maintain a temperature in the quench tank that is different than the dying temperature. As the filament 20 is pulled through the quench tank 130 by a set of nip or feed rolls 131, it is simultaneously quenched and ring-dyed. The parameters maintained within the tank 130, e.g., dye concentration, temperature, immersion time, pH, etc., depend upon the type of filament material being utilized, e.g., polyamide or polyester, and are similar to those described in connection with the first embodiment discussed above and shown in FIG. 6.

The filaments 20 are then contacted with a plurality of vacuum stripper tubes 125 that remove excess quench water and dye from the filaments 20. The quench tank 130 to which the dye solution has been added is heated by submerged heaters (not shown) to facilitate the reaction between the filaments 20 and the dye solution. The temperature of the water in the tank is still low enough to effectively quench cool and solidify the filament at the same time that the filament is being ring-dyed. Also, because the filament 20 remains hot from extrusion and because the quench tank 130 is heated, more rapid uptake of the dye solution by the filament surface results. As in the first embodiment, under this embodiment, a reduction in the amount of time to obtain the desired level of dye penetration in the filaments 20 is realized.

The filaments 20 are then pulled through a rinse tank 135 by a set of nip or feed rolls 137. The rinse tank 135 is filled with any suitable rinsing medium, e.g., water, to rinse any residual dye remaining on the filaments 20 as they exit the quench tank 130. The filaments 20 then are contacted with a second plurality of vacuum stripper tubes 139 that remove excess dye and water from the filaments 20. The remaining process steps, i.e., stretching, annealing, lubricating and collecting of the filaments 20, are identical to those described under the first exemplary embodiment in FIG. 6.

Referring now to FIG. 8, a schematic representation of the most preferred embodiment of the present invention is shown. The most preferred embodiment, in the form of a process line usable to form filaments 20 in accordance with this invention is shown at 320. Under this embodiment, both the dye tank 133 and the rinse tank 135 have been eliminated with only the quench tank 130 remaining to which the dye solution has been added. Effectively, under the most preferred embodiment, rinsing has been eliminated from the process and both quenching and dying steps are performed simultaneously in a single tank. This most preferred embodiment may be utilized where it is not necessary to maintain a temperature in the quench tank that is different than the dying temperature and where rinsing of the filament 20 following ring-dying is not necessary. As the filament 20 is pulled through the quench tank 130 by a set of nip or feed rolls 131, it is simultaneously quenched and ring-dyed. The type of dye solution specified is based upon the type of material of the filament 20, e.g., polyamide or polyester, as described previously in connection with the two previous embodiments discussed in FIGS. 6 and 7. Likewise, the parameters maintained within the tank 130, e.g., dye concentration, temperature, immersion time, pH, etc., are similar to those described in connection with the two previous embodiments discussed above and shown in FIGS. 6 and 7. The quench tank 130, to which the dye solution has been added, is heated by submerged heaters (not shown) to facilitate the reaction between the filaments 20 and the dye solution. The filaments 20 are then contacted with a plurality of vacuum stripper tubes 125 that remove excess quench water and dye from the filaments 20. The temperature of the water in the tank is still low enough to effectively quench, cool and solidify the filament at the same time that the filament is being ring-dyed. Also, because the filament 20 is still hot from extrusion and because the quench tank 130 is heated, more rapid uptake of the dye solution by the filament surface results. As in the first two embodiments, under this embodiment, a reduction in the amount of time to obtain the desired level of dye penetration in the filaments 20 is realized. The remaining process steps, i.e., stretching, annealing, lubricating and collecting of the filaments 20, are identical to those described under the first exemplary embodiment in FIG. 6.

Although this invention has been illustrated by reference to specific embodiments and variations, it will be apparent to those skilled in the art that various changes and modifications may be made which clearly fall within the scope of the invention.

1. A continuous process for the manufacture of a ring-dyed filament, said process comprising the steps of:
a. continuously extruding a polymer melt from an extruder to form the filament; and,
b. continuously feeding the extruded filament into a tank containing a dye solution and maintaining the filament in the tank for a predetermined period of time to provide a ring-dyed filament having an outer cross-sectional region colored with said dye and an inner cross-sectional region not colored with said dye.

2. A process as in claim 1, wherein the outer cross-sectional region of the filament is of a substantially uniform thickness over the length of the filament.

3. A process as in claim 1, wherein during said ring-dyeing step (b), said process comprises the further step of quenching the filament downstream of said extrusion step (a).

4. A process as in claim 1, wherein immediately following said extruding step (a) and prior to said ring-dyeing step (b), said process comprises the step of quenching the filament.

5. A process as in claim 4, wherein said step of quenching is carried out by utilizing positively driven feed rollers for directing the filament through a water bath.

6. A process as in claim 1, wherein said ring-dyeing step (b) has a duration of between less than 1 and 30 seconds.

7. A process as in claim 1, wherein the filament is formed of a polyamide.

8. A process as in claim 1, wherein following said ring-dyeing step (b), said process comprises the further step of directing the filament into a first heated zone under a predetermined tension and stretching the filament to a predetermined cross-sectional dimension.

9. A process as in claim 8, wherein said stretching step only occurs following said ring-dying step (b).

10. A process as in claim 8, wherein said stretching step comprises multiple stretching steps.

11. A process as in claim 8, wherein following said stretching step, said process comprises the further step of passing the filament through a second heated zone under a controlled degree of relaxation and annealing the filament.

12 A process as in claim 11 wherein immediately following said annealing step, said process comprises the further step of coating the filament with a lubricant.

13. A process as in claim 12, wherein said coating step includes the step of contacting the filament with a lubricant applicator roll.

14. A process as in claim 1, wherein said filament is formed of a polymeric composition.

15. A process as in claim 8, wherein said step of stretching is imposed upon the filament by positively driving feed rollers of a second roll stand and positively driven rollers of a first roll stand, the feed rollers of the second roll stand being driven at the same speed but faster than the rolls of the first roll stand, the filament being conveyed from said first roll stand to said second roll stand.

16. A process as in claim 1, wherein the outer cross-sectional region of the filament tapers over the length of the filament.

17. A process as in claim 11, wherein said annealing step includes the step of directing the filament through and out of an annealing oven by positively driven feed rolls.

18. A process as in claim 1, wherein said dye solution comprises between 0.01% and 0.5% weight to volume of a suitable dye, said solution having a pH between 0 and 7, said solution being maintained at a temperature between 20 and 100 degrees C.

19. A process as in claim 3, wherein immediately following said ring-dyeing step (b), said process comprises the further step of rinsing said ring-dyed filament.

20. A process as in claim 4, wherein immediately following said ring-dyeing step (b), said process comprises the further step of rinsing said ring-dyed filament.

21. A process as in claim 19, wherein said step of rinsing includes the step of utilizing positively driven feed rollers to direct the filament through a water bath to remove excess dye.

22. A process as in claim 20, wherein said step of rinsing includes the step of utilizing positively driven feed rollers to direct the filament through a water bath to remove excess dye.

23. A process as in claim 1, wherein following said ring-dyeing step (b), said process comprises the further step of collecting the filament on a reel.

24. A process as in claim 1, wherein following said ring-dyeing step (b), said process comprises the further step of cutting the filament to predetermined lengths.

25. A process as in claim 1, wherein the filament is formed of a polyester.

26. A process as in claim 1, wherein the filament includes a hollow central axis.

27. A process as in claim 7, wherein said polyamide is selected from the group consisting of polyamide 6-12, polyamide 10-10, polyamide 6-10, polyamide 6-6 and polyamide 6.

28. A process as in claim 25, wherein said polyamide is selected from the group consisting of polyethylene terephthalate, polybutylene terephthalate, and, polytrimethylene terephthalate (PTT).

29. A process as in claim 1, wherein the filament is formed of a blend of a polyamide and another polymer.

30. A process as in claim 1, wherein the filament is formed of a blend of a polyester with another polymer.

31. An apparatus for the manufacture of a ring-dyed monofilament, said apparatus comprising:
a. an extruder section for continuously extruding a polymer melt to form the filament in a downstream direction; and,
b. means for continuously feeding the extruded filament into a tank containing a dye solution and for maintaining the filament in said tank for a predetermined period of time to provide a ring-dyed filament having an outer cross-sectional region colored with said dye and an inner cross-sectional region not colored with said dye.

32. The apparatus as in claim 31, additionally comprising means for quenching said filament, said means being situated downstream from said extruder section.

33. The apparatus as in claim 32, wherein said means for quenching comprises a tank containing water.

34. The apparatus as in claim 31, additionally comprising means for heating and means for stretching said filament.

35. The apparatus as in claim 34, wherein said means for heating said filament comprises an oven.

36. The apparatus as in claim 31, additionally comprising a tank for rinsing residual dye remaining on said filament.

37. The apparatus as in claim 31, additionally comprising means for lubricating the filament.

38. The apparatus as in claim 31, additionally comprising means for stretching said filament, said means being located downstream from said means for ring-dyeing said filament.

39. The apparatus as in claim 31, wherein said means for stretching said filament comprises positively driving feed rollers of a second roll stand and positively driven rollers of a first roll stand, the feed rollers of said second roll stand being driven at the same speed but faster than the rolls of said first roll stand, the filament being conveyed from said first roll stand to said second roll stand.

40. A continuous process for the manufacture of a ring-dyed filament having more than one ring-dyed region, said process including the steps of:
a. continuously extruding a polymer melt from an extruder to form the filament; and,
b. continuously feeding the extruded filament into one or more tanks containing at least a first dye and a second dye, said second dye being different in color and more absorbed by the filament than said first dye; and,
c. maintaining the filament in said one or more tanks for a predetermined period of time to provide a ring-dyed filament having an outer cross-sectional region colored by said first and second dyes and an inner cross-sectional region colored by said second dye only.

41. The dying process of claim 40 wherein said one or more tanks comprises a single tank and wherein said first and second dyes are mixed together therein.

42. The dying process of claim 40 wherein said one or more tanks comprises a first tank containing said first dye and a second tank containing said second dye.

43. A continuous process for the manufacture of a ring-dyed filament, said process consisting essentially of the steps of:
a. continuously extruding a polymer melt from an extruder to form the filament; and,
b. continuously feeding the extruded filament into a tank containing a dye solution and maintaining the filament in the tank for a predetermined period of time to provide a ring-dyed filament having an outer cross-sectional region colored with said dye and an inner cross-sectional region not colored with said dye.
